(19) United States
(12) Patent Application Publication
(10) Pub. No.: US 2020/0209980 A1
(43) Pub. Date: Jul. 2, 2020

(54) Laser Pointer Screen Control

(71) Applicant: John C. Wright, King George, VA (US)

(72) Inventor: John C. Wright, King George, VA (US)

(73) Assignee: United States of America as represented by the Secretary of the Navy, Arlington, VA (US)

(21) Appl. No.: 16/234,653

(22) Filed: Dec. 28, 2018

(51) Int. Cl. G06F 3/033; G06F 3/03

(52) U.S. Cl. CPC G06F 3/033; G06F 3/0304

(57) ABSTRACT

A system is provided for controlling visual presentation of information content in memory to an audience by a projector towards a display screen. A computer sequences the projector. The system includes a laser emitter, an optical sensor, and a processor. The laser emitter projects a laser beam to the screen. The optical sensor detects a beam reflection from the screen at a location. The processor assigns a region on the screen to a presentation command. The processor also responds to the reflection at the location corresponding to the region with instruction to the projector for executing the command.

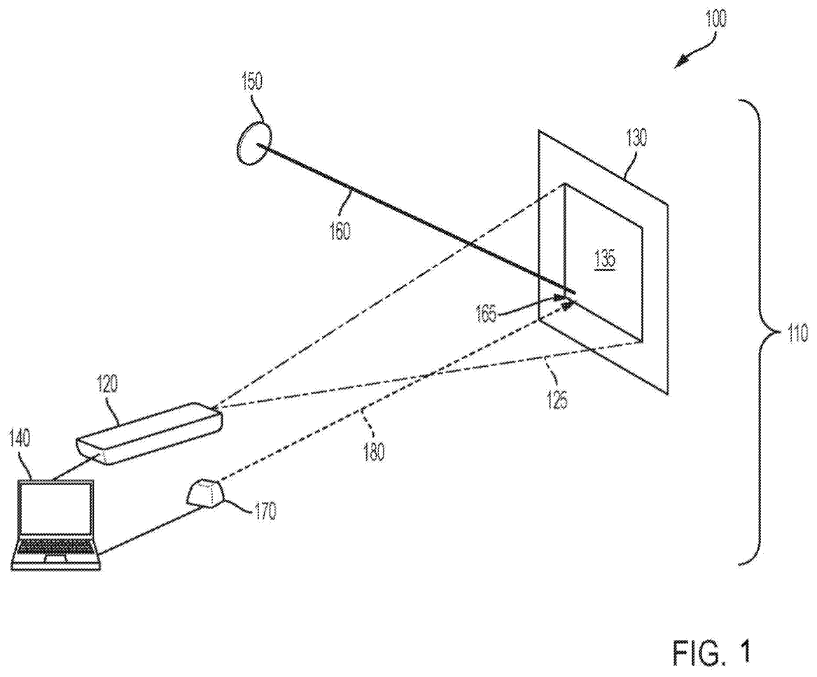

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to wireless screen control. In particular, the invention relates to laser pointing and detection for controlling a screen presentation to an audience.

In various meetings and symposiums, audio-visual presentations convey information to audience members in an auditorium or similar venue. These presentations exhibit text, image, sound or other related optical and/or auditory content via a projector and/or a speaker within that room. The projector can be controlled by a remote control switch to sequence forward or backward through pages (or slides) of the content. The projector can be controlled by the hand-held switch by communication wires (bundled in a flexible cable) or transmitted wirelessly via radio frequency (RF) or else infrared (IR) emission.

The switch provides the necessary capabilities needed to allow a presenter to step slides forward and backward or to provide control signals to the computer via an interface. These switches for presentation control work adequately and are readily available. Some presentations are conducted in a closed forum due to their sensitivity. Under such circumstances, the room may be confined rendering wire links undesirable, and conventional wireless techniques presenting unacceptable detection risk.

The first limitation involves RF in the control system, usually using Wi-Fi protocol for the communications. These systems exhibit potential security vulnerabilities associated with RF communications and Wi-Fi systems. Many facilities configured as conference facilities will not permit RF communications for this reason. A second limitation is that of range. Many models of presentation control have range limitation due to the low power level used in the conventional switches. This limitation is typically an issue in large conference areas and can be overcome by increasing the power level of the transmitting switch, thereby augmenting the potential for unauthorized interception.

### SUMMARY

Conventional audio-visual projection controls yield disadvantages addressed by various exemplary embodiments of the present invention. In particular, various exemplary embodiments provide a system for controlling visual presentation of information content in memory to an audience by a projector towards a display screen. A computer sequences the projector.

In exemplary embodiments, the system includes a laser emitter, an optical sensor, and a processor. The emitter, projects a laser beam to the screen. The optical sensor detects a beam reflection from the screen at a location. The processor assigns a region on the screen to a presentation command. The processor also responds to the reflection at the location corresponding to the region with instruction to the projector for executing the command.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIGURE is a block diagram view of a projector with laser on

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, artisans of ordinary skill will readily recognize that devices of a less general purpose nature, such as hardwired devices, may also be used without departing from the scope and spirit of the inventive concepts disclosed herewith. General purpose machines include devices that execute instruction code. A hardwired device may constitute an application specific integrated circuit (ASIC), a field programmable gate array (FPGA), digital signal processor (DSP) or other related component.

FIGURE shows a block diagram view 100 of an exemplary display projection system 110 with laser control for presentation to an audience. A display projector 120 projects an image via light emission 125 to a display screen 130 to display an image 135. A general purpose computer 140 controls the projector 120 and typically stores in its memory the content pages of the presentation for visual display.

A laser pointer 150 emits a coherent monochromatic light beam 160 onto a spot location 165 on the screen 130 for controlling the presentation sequencing. The laser pointer 150 denotes a low-power emitter of laser light used to highlight particular regions of the image 135. An optical sensor in a housing 170 detects the beam's reflected light 180 from the location 165 and issues a correlation signal to the computer 140 for controlling the projector 120. The sensor has sensitivity to ascertain location 165 in relation to area region of the screen 130. The room can be several meters in length, width and height.

System incorporation of the pointer 150 and sensor 170 enables wireless control of the projector 120 without broadband radio frequency (RF) emission. The laser pointer 150 can operate within the visible light portion of the electromagnetic spectrum, preferably in the green color (wavelength ˜550 nm), although other wavelengths for other colors can alternatively be used. The laser light can be continuous, or intermittent as in a strobe.

Exemplary embodiments provide a laser presentation controller to satisfy the need for visual presentation control in spaces where RF (e.g., Wi-Fi) devices are not permitted. An example would be a presentation offered in an open secret space where security concerns prohibit the operation of a presentation controller that receives Wi-Fi to connect the hand-held controller to the computer 140. Typical solutions to this restriction are for an additional person to be present at the computer 140 and to then control the slides based on the presenter's verbal or non-verbal direction.

Exemplary embodiments enable the presenter to shine a laser pointer 150 to control the presentation thus enabling the presenter to directly control the flow of the presentation without the presence or involvement of an auxiliary person. A unitary detector housing 170 connecting to the computer 140 contains a focusing lens, the laser sensor, and an image processor. Such a lens can be incorporated for magnification or other related augmentation such as laser range adjustment.

Alternatively, the lens, sensor and processor (along with associated' interface connections) can be incorporated into the projector 120 as a design modification, The processor assigns control commands to particular locations 165 on the image 135 being projected onto the screen 130. The sensor in the housing 170 then scans the incoming image 135 for the laser reflection 180 from the screen 130 and reports the locations 165 of detection to the processor.

The processor can be instructed with default locations that correlate to the advance, backwards, and other slide command. When the associated location 165 on the screen 130 is reported has receiving the laser beam 160, the processor then sends the appropriate command over a universal serial bus (USB) interface to the computer 140 for executing software that (analogous to a conventional RF controller but absent the security vulnerability) causes the presentation to advance or retard appropriately to the command.

The processor in the housing 170 is programmable to enable laser characteristics such as color, pulse rates, number of pulse, etc. for restricting response from a unique laser to control the presentation of content (sequencing forward and back), or if desired for any laser to control this page sequence. This also applies to dwell time in the location 165 on the image 135 before detection is treated as initiating a control action instead of merely pointing to an image portion for emphasis to the audience.

The processor can assign locations 165 on the screen 130 for control options under operator selection. For example, a projection to the screen 130 of the beam 160 of lower left corner for backward, lower right for forward, upper left as blank and upper right as un-blank could represent an assigned scheme. With selection of this projection assignment, the beam 160 can illuminate the location 165 that the sensor in the housing 170 detects, causing the processor to instruct the computer 140 to control the projector 120 via their USB ports to implement the appropriate action.

In the example scheme, a presenter would shine the laser pointer 150 into the lower right corner of the screen 130 to cause the projector 120 to advance the presentation page. For the reverse, the presenter would shine the laser pointer 150 into the lower left corner of the screen 130 to cause the projector 120 to retreat the presentation page.

Exemplary embodiments thus eliminate the RF interface between the presenter's hand controller and the host computer 140. The elimination of this interface removes the potential for security issues, obviates auxiliary personnel for presentation control, and provides for additional aspects of presentation control via laser pointers.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

1. A system for controlling visual presentation of information content in memory to an audience by a projector towards a display screen, a computer sequencing said projector, said system comprising:
a laser emitter for projecting a laser beam to the screen;
an optical sensor for detecting a beam reflection from the screen at a location; and
a processor for assigning a region on the screen to a presentation command, and responding to said reflection at said location corresponding to said region over a threshold dwell time with instruction to the projector for executing said command.

2. The system according to claim 1, further including a lens upstream of said sensor to magnify said beam reflection.

3. The system according to claim , wherein said command is at least one of sequencing forward and backward.

4. The system according to claim 1, wherein said laser emitter operates one of continuously and intermittently.
